(19) United States
(12) Patent Application Publication
(10) Pub. No.: US 2011/0199779 A1
(43) Pub. Date: Aug. 18, 2011

(54) LUMINOUS COSTUME STRUCTURE

(76) Inventor: Wu-I Chu, Taipei (TW)

(21) Appl. No.: 12/908,874

(22) Filed: Oct. 20, 2010

(30) Foreign Application Priority Data
Feb. 12, 2010 (CN) 099203284

(51) Int. Cl. G02B 6/00; F21V 21/08

(52) U.S. Cl. 362/551; 362/103

(57) ABSTRACT

A luminous costume structure mainly includes: a costume, a light guiding element being sewed on an outer surface thereof, and a storage portion being configured thereon; a light emitting element, connected to a terminal of the light guiding element; and a control circuit, including a circuit board and a battery, configured in the storage portion of the costume, and having a conducting wire connected to the light emitting element, thereby controlling a lighting way of said light emitting element. Whereby, light emitted from the light emitting element can be transmitted to the light guiding element of the costume, and radiate to the outside, thereby achieving an enforced brightness warning and an eye-appealing outlook of the costume.

### BACKGROUND OF THE INVENTION

1. Field of the Invention

The present invention relates a luminous costume structure, and more particularly to a luminous costume structure configured with a light guiding element sewn on an edge or a seam of a costume or an accessory; the luminous costume structure is stable, easy to be manufactured, convenient to be stored and can increase the eye-appealing outlook and the entirety of a costume or an accessory.

2. Background

Accompanying the development of industry and commerce societies, the people's life style is also influenced and changed. The number of night workers, such as traffic polices, scavengers and road construction workers, increases gradually. In addition, many people will also ride a bicycle at night accompanying the proper development of the bicycle riding leisure sport. But, also because pedestrians and vehicles on roads at night are less crowded than in the daytime, vehicle drivers might speed vehicles insensibly to put general riders, pedestrians, or night workers on the road such as traffic polices, scavengers and road construction worker in the danger of a traffic accident easily.

A conventional safety alarm structure such as reflectors are respectively installed on the rear side of a general bicycle body and the front and rear sides of a pedal to strengthen light reflection thereby using them as a warning to prevent a night bicycle rider from being endangered. In addition, reflectors may be sewed on a costume for the reflection of a vehicle lamp, thereby forcibly noticing a vehicle driver to pay especial attention to pedestrians or workers. But, such kind of reflection structure is passive; it must receive an external light and then is able to reflect a vehicle lamp light to give a warning, and the material of the reflector and outside lightness can also influence the light reflecting effect; the reflecting effect is good when light is projected directly or light is bright in a clear day, allowing drivers to act normally. But, a reflecting effect is bad relatively if a pedestrian is at a corner of a roadside where vehicle lamp light is unable to reach or vehicle lamp light is diffused in a rainy day, a driver cannot react immediately accordingly such that a collision might happen easily, and even worse, a serious traffic accident might be caused.

Thereupon, actively luminous warning structures are respectively disclosed in patents such as Taiwan Utility Model Patent No. 93220106 titled as “Easily Coupled Light Transmissive Structure and Optical Transmission Device Therewith” and Taiwan Utility Model Patent No. 93217265 titled as “Optical Transmission Device”.

The light transmission device disclosed in Taiwan Utility Model Patent No. 93220106 has a light source and a light transmissive structure, where the light source is constituted by a photoproduction device and a light emitter, and the light transmissive structure then has an enough transparency to radiate received light to the outside. The light transmissive structure includes a cylindrical main body and a thin sheet structure extended from the circumference of the main body, where a slit may be opened on the thin sheet structure, and adapted to engage with and fixed to a button on clothes, or the thin sheet structure may be sewed on the clothes directly, thereby fixing the light transmissive structure on the clothes. But, the defects of the light transmission device are: the light transmission structure without a light guiding is only limited to radiate the light to the outside, causing light not to be able to be transmitted to the terminal of the light transmission device if the light transmission device is too long such that a user's safety cannot be protected effectively. In addition, the entire outlook of the light transmission device is not eye-appealing because the light transmission device is engaged with a button of clothes with the slit or by sewing it on clothes directly. In addition, the specification of the patent does not describe anything about how to install the photoproduction device. Even though, it can be figured out that the photoproduction device shown in the figures of the patent is connected to the light emitter, and the light emitter is also connected to the light transmissive structure. From this point of view, the photoproduction device should be exposed on the surface of clothes. But, the photoproduction device includes circuits, a battery holder, housing and etc such that the volume thereof is presumably very large; it is easy to cause a user's motion to be inconvenient while wearing clothes with the light transmission device, and the photoproduction device to be damaged due to the outside collision or friction. Conclusively, the light transmission device improves slightly the defects of light transmission of the light transmissive structure mentioned above, but it does not disclose and explain how to install the light transmission device on clothes.

### SUMMARY OF THE INVENTION

To improve a light transmission device and the fixation thereof on clothes and match the requirements of modern economics, eye-appealing sense and practical use, the present invention is proposed.

The present invention proposes a luminous costume structure, mainly including a costume, a light guiding element being sewed on an outer surface thereof, a storage portion being configured thereon; an luminous element, connected to a terminal of the light guiding element; and a control circuit, including a circuit board and battery, configured in the storage portion of the costume, and having a conductive wire connected to the luminous element so as to control a lighting way of the luminous element, thereby allowing the light emitted from the luminous element to be transmitted to the light guiding element on the costume and then radiate to the outside to achieve a warning effect.

### BRIEF DESCRIPTION OF THE DRAWINGS

The present invention can be more fully understood by reference to the following description and accompanying drawings, in which:

FIG. 1 is a schematic view of a luminous costume structure of the present invention;

FIG. 2 is a perspective view of a luminous costume structure of the present invention;

FIG. 3 is a cross-sectional view of a luminous costume structure, taken along line A-A of FIG. 1;

FIG. 4 is a cross-sectional view of a luminous costume structure, taken along line B-B of FIG. 3;

FIG. 5 is a schematic view of a luminous costume structure of another preferred embodiment according to the present invention; and

FIG. 6 is a schematic view of a light guiding element of another preferred embodiment according to the present invention.

### DETAILED DESCRIPTION OF THE PREFERRED EMBODIMENTS

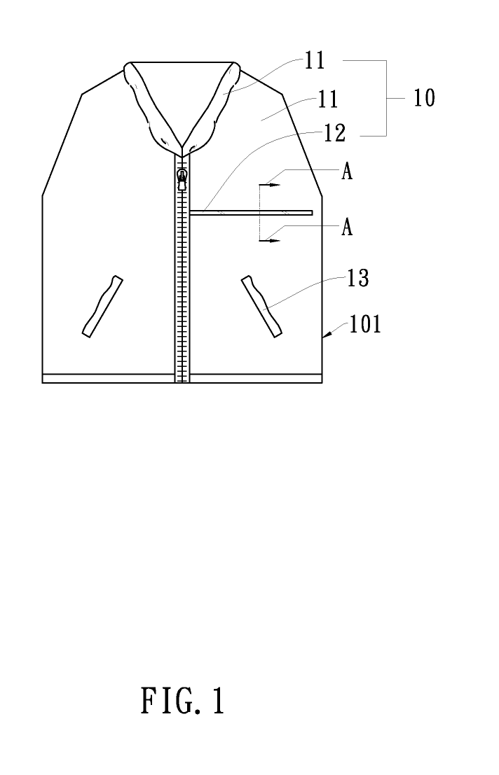

First, referring to FIGS. 1 to 4, a luminous costume structure mainly includes a costume 10, a light emitting element 20 and a control circuit 30.

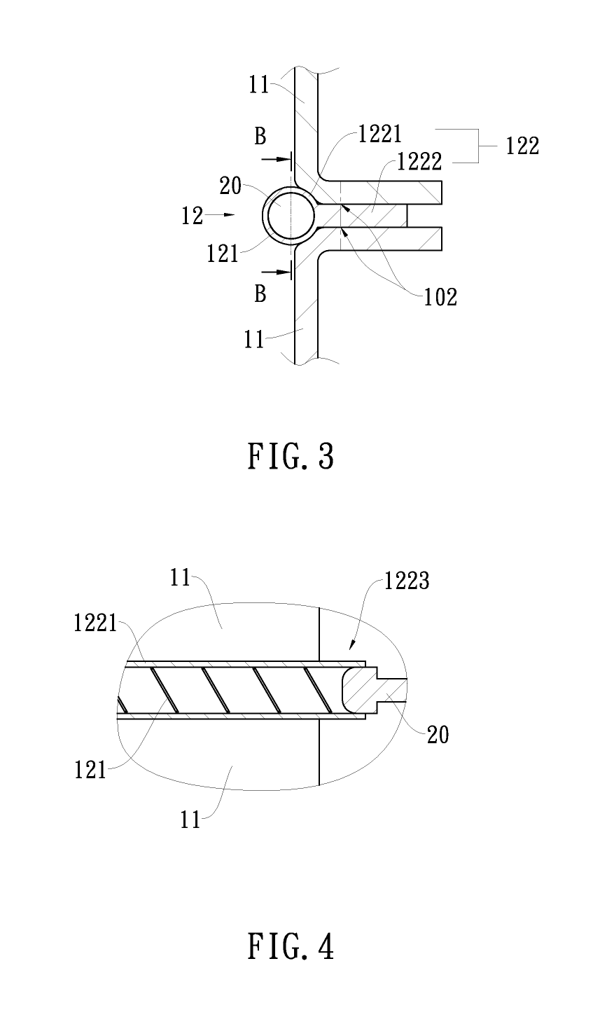

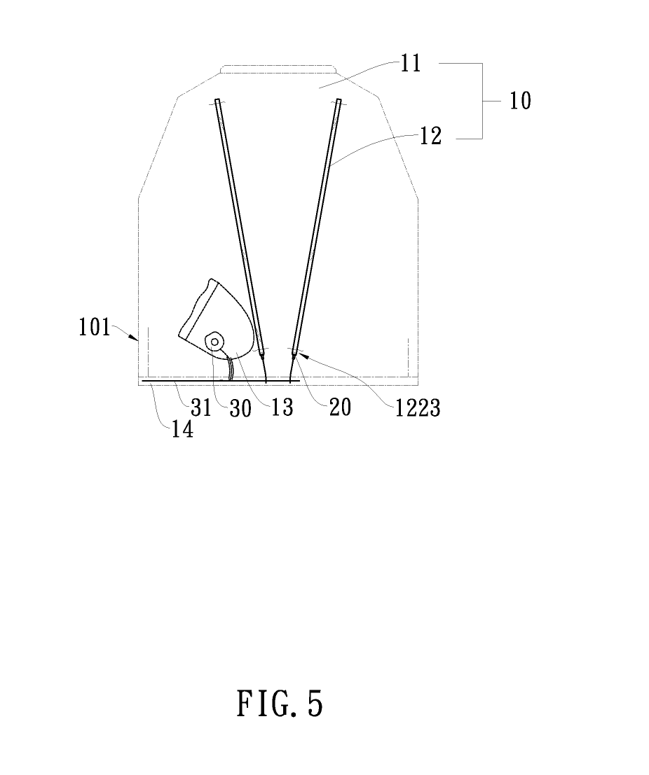

The costume 10 may be a clothing such as top, coat, trousers or accessory worn on a human body such as cap, canvas shoe, scarf, and is formed by sewing a plurality of garment sections 11 including front sections, rear sections, sleeve sections and etc together, where the front section, the rear section or the sleeve section may be formed by one single garment section 11 or a plurality of garment sections 11 sewed together. A light guiding element 12 is sewed on the outer surface of the garment section 11 of the costume 10, and distributed linearly on the light guiding element sewed on the garment section 11 as FIG. 5 shows or between the two garment sections 11 as FIG. 3 shows. Furthermore, a storage portion 13 is configured on the costume 10, where the storage portion 13 may be a bag of conventional clothes such as a top. In addition, a storage passage 14 communicating with the storage portion 13 is sewed on an edge 101 or a seam 102 of the costume 10, where the light guiding element 12 has at least one light guiding fiber 121, and a transparent cover configured on the outer layer thereof; the transparent cover 122 is constituted by a hollow tube 1221 and a side sheet 122 extended form one side thereof, thereby sewing the side sheet 1222 of the transparent cover 122 on the single garment section 11, or clipping it between the two sheets of garment sections 11 of the costume 10. In addition, the terminal of the tube 1221 is disposed with an elongated section 1223 for the engagement of a light emitting element 20, where the light guiding element 12 may also be twisted into characters and/or graphs distributed between the two garment sections 11, and the light guiding fiber 121 of the light guiding element 12 may also be a screw-typed body configured in the transparent cover 122.

The light emitting element 20 is connected to the terminal of the light guiding element 12, and the light emitting element 20 may be a LED, light bulb or other element with a light source.

A control unit 30 includes a circuit board and a battery (not shown in the figures), configured in the storage portion 13 of the costume 10, and has a conducting wire 31 accepted in the storage passage 14, where the conducting wire 31 is connected to the light emitting element 20, thereby controlling the lighting way of the light emitting element 20.

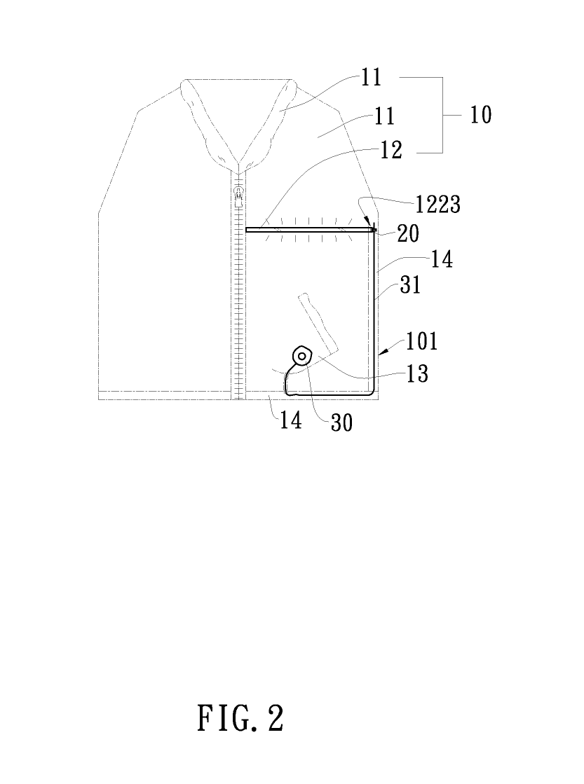

Referring to FIG. 2 again, a user may press the control circuit 30 in the storage portion 13 of the costume 10 after wearing the costume 10, and the light emitting element is then turned on through the conducting wire 31, allowing the light emitting element 20 to illuminate and transmit the light into the light guiding fiber 121 of the light guiding element 12 of the costume 10, and the light can then be conducted through the light guiding fiber 12 to the terminal thereof and radiate through the transparent cover 122 to the outside, thereby achieving an enforced luminous warning and eye-appealing outlook. In addition, referring to FIG. 5, FIG. 5 shows another preferred embodiment of the present invention. The light guiding element 12 may be configured on the back of the costume 10, and may also be configured on any place of the costume 10. Furthermore, the conducting wire 31 may be passed through the hollow tube 1221 directly for the convenient configuration of the light guiding element 12 and the eye-appealing outlook thereof.

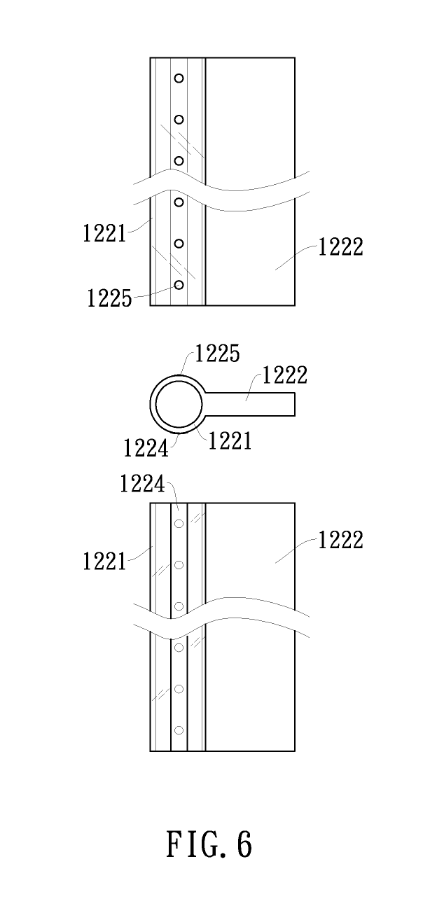

Referring to FIG. 6, FIG. 6 shows a light guiding element 12 of another preferred embodiment according to the present invention. A reflecting layer 1224 for brightness enhancement may be configured on the transparent cover 122 of the light guiding element 12 close to one side of the costume 10, and a plurality of variable density masking mesh points 1225 may also configured on the front and the rear of one side of the transparent cover 122 facing the outside, thereby achieving the uniform front and rear brightness of the light guiding element 12.

Therefore, the brightness insufficiency caused by the conventional light transmission, and the improper consideration of the configuration of a conventional light emitting structure and the disposition thereof on clothes, articles can be improved obviously through the particular design of the present invention, thereby preventing a user's motion from being interferenced, and the structure from being damaged due to external collisions or abrasion. Furthermore, the present invention can increase the eye-appealing outlook and the entirety of the costume 10 by coupling the plurality of garment sections 11 of the costume 10 to the side sheet 1222 of the light guiding element 12, and installing the light emitting element 20, the control circuit 30 and the conducting wire 31 in the storage portion 13, the storage passage 14 of the costume 10.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A luminous costume structure, comprising:
a costume, a light guiding element being sewed on an outer surface thereof, and a storage portion being configured thereon;
a light emitting element, connected to a terminal of said light guiding element;
a control circuit, comprising a circuit board and a battery, configured in said storage portion of said costume, and having
a conducting wire connected to said light emitting element, thereby controlling a lighting way of said light emitting element.

2. The luminous costume structure according to claim 1, wherein said light guiding element has at least one light guiding fiber.

3. The luminous costume structure according to claim 2, wherein a transparent cover is configured on an outer layer of said light guiding fiber.

4. The luminous costume structure according to claim 3, wherein said transparent cover is a hollow tube.

5. The luminous costume structure according to claim 4, wherein a side sheet is extended from one side of said hollow tube.

6. The luminous costume structure according to claim 5, wherein an elongated section adapted to engage with said light emitting element is configured on a terminal section of said hollow tube.

7. The luminous costume structure according to claim 5, wherein said light guiding fiber of said light guiding element is spirally configured in said transparent cover.

8. The luminous costume structure according to claim 7, wherein a reflecting layer for brightness enhancement is configured on one side of said transparent cover close to said costume.

9. The luminous costume structure according to claim 8, wherein a plurality of variable density masking mesh points are configured on a front and rear of one side of said transparent cover facing the outside, thereby achieving uniform brightness of a front and said rear of said light guiding element.

10. The luminous costume structure according to claim 5, wherein said costume is formed by sewing a plurality of garment sections together, and said side sheet of said transparent cover is sewed on said garment section.

11. The luminous costume structure according to claim 5, wherein said costume is formed by sewing a plurality of garment sections together, and said side sheet of said transparent cover is clipped between the two garment sections of said costume.

12. The luminous costume structure according to claim 11, wherein a storage passage communicating with said storage portion for accepting said conducting wire is configured on said costume.

13. The luminous costume structure according to claim 12, wherein said storage passage is sewed on an edge or a seam of said costume.

14. The luminous costume structure according to claim 13, wherein said light guiding element is linearly distributed between said two garment sections.

15. The luminous costume structure according to claim 13, wherein said light guiding element is distributed between the two garment sheets in the form of characters or graphs.

16. The luminous costume structure according to claim 9, wherein said costume is formed by sewing a plurality of garment sections together, and said side sheet of said transparent cover is clipped between the two garment sections of said costume.

17. The luminous costume structure according to claim 10, wherein said light guiding element is linearly distributed on said garment section.

18. The luminous costume structure according to claim 17, wherein said conducting wire is passed through said hollow tube.
